(19) United States
(12) Patent Application Publication
(10) Pub. No.: US 2006/0180285 A1
(43) Pub. Date: Aug. 17, 2006

(54) High quality and long natural cellulose fibers from rice straw and method of producing rice straw fibers

(76) Inventors: Yiqi Yang, Lincoln, NE (US); Narendra Reddy, Lincoln, NE (US)

Correspondence Address: SUITER WEST SWANTZ PC LLO, 14301 FNB PARKWAY, SUITE 220, OMAHA, NE, 68154, US

(21) Appl. No.: 11/338,444

(22) Filed: Jan. 24, 2006

Related U.S. Application Data
(60) Provisional application No. 60/648,335, filed on Jan. 28, 2005.

(51) Int. Cl. B03B 5/00

(52) U.S. Cl. 162/90

(57) ABSTRACT

A method and kit for rice fiber extraction is provided. In an exemplary embodiment, the method may include treating rice straw with an alkali solution such as a sodium hydroxide solution. Further, the method may include extracting coarse rice fibers from the rice straw and treating the extracted coarse rice fibers with an enzyme solution. For instance, the enzyme solution may include cellulase and a xylanase preparation. Implementation of the method results in high quality natural cellulose rice fibers which may be suitable for all textile applications that use natural cellulose fibers (e.g., cotton and linen). In addition, extracted rice fibers that are at least ten (10) millimeters in length, no more than 0.5 millimeters in width and include a generally smooth surface are disclosed. For example, textile or composite products may be produced with such rice fibers.

### CROSS REFERENCE TO RELATED APPLICATIONS

The present application claims the benefit under 35 U.S.C. §119(e) of U.S. Provisional Patent Application Ser. No. 60/648,335, entitled “High Quality and Long Natural Cellulose Fibers from Rice Straw and Method of Producing the Fibers,” filed Jan. 28, 2005 which is herein incorporated by reference in its entirety.

### FIELD OF THE INVENTION

The present invention relates generally to natural cellulose fiber production, and particularly to fibrous products made from natural cellulose fibers obtained from rice straw.

### BACKGROUND OF THE INVENTION

With an availability of more than 580 million tons worldwide every year, rice straw is one of the most common sources of biomass available. Currently, there is very limited use of rice straw in construction, agriculture, paper, packing, fuel and energy industries. First, most of the rice straw available after harvest is either left on the ground or burnt. Tilling the straw left on the ground into the soil may be expensive. In addition, rice straw may have slow degradation rates, clogs field implements, is reported to harbor rice diseases and also inputs excess amounts of minerals into the soil. Although burning of rice straw is fast, economical and kills disease causing bacteria, the pollution generated by rice straw burning may pose a threat to the environment.

Although rice straw may be used for paper and fuel, such uses are associated with various limitations. For example, rice straw may include about 3 to 14% silica which has been reported to damage the pulping equipment when rice straw is used for paper. Further, with the existing technologies, using rice straw for ethanol or other fermentation products is not economical due to the possible low cellulose to glucose conversion rates. Thus, these limitations restrict the use of rice straw for industrial applications.

It is contemplated, however, that rice straw may have additional applications which remain to be fully explored. For example, rice straw may be used in fibrous applications such as composites and textiles. Industries using fibers are seeking a cheap and environmentally friendly alternative to the natural and synthetic fibers in current use due to several disadvantages associated with the production and use of these fibers. Natural fibers such as cotton need land, water and other natural resources to grow. Growing cotton may be environmentally unfriendly since such production often requires vast amounts of insecticide. Moreover, synthetic fibers are often from non-renewable petroleum resources. Further, synthetic fibers may consume more energy than that required to produce fibers from a renewable resource thereby making the process of synthetic fiber production environmentally unfriendly. Further, products made from synthetic fibers are difficult to be disposed after use. Thus, the need to find alternative sources for fibers, especially from the annually renewable resources, remains.

Agricultural byproducts such as cornhusks, corn stalks, pineapple and banana leaves, and coconut husks (coir fibers) have been used to extract natural cellulose fibers. However, not all of these byproducts may be used to produce fibers with properties required for high quality applications. The source, availability, composition and extraction conditions used to obtain the fibers influences the properties, processability and economics of fiber production. Coir fibers are coarse, have lower strength than most natural fibers but have high elongation. Coir is generally used for applications such as low value carpets, floor rugs and mats. Pineapple leaf and banana stems are available to a limited extent and require specific climate to grow. Producing fibers from these sources may not be economical. On the other hand, corn is the most widely grown crop in the world and the byproducts of corn production, cornhusks and corn stalks, are available in relatively large quantities and can be used to produce high quality fibers. Rice and wheat are also widely grown across the world and are second only to corn in terms of the worldwide production. Currently, no methods are known to be capable of producing high quality natural cellulose fibers from rice straw.

Rice straw generally contains about 35% cellulose, 30% hemicellulose, 15% lignin and about 20% ash. The cellulose fibers in rice straw are interconnected to each other to form large bundles with the widths of hundreds of micrometers to millimeters. They are then connected to each other by films. The ultimate fibers in rice straw are about 0.4 to 1.0 mm in length. These ultimate fibers are too short and/or too weak to be used for textile and other high value fibrous applications. To be classified as a textile fiber, the fiber should have a length at least 1000 times its' diameter with adequate tensile strength and elongation. For practical purposes, fiber length is required to be at least 1.0 cm and possess a strength greater than 1 gram per denier (denier is a common term used to describe the fineness or linear density of a textile material).

Although no methods are known to be capable of producing high quality natural cellulose fibers from rice straw, some methods used to obtain fibers from rice straw for paper and composite applications have been previously reported. For instance, a method of making boards from agricultural waste products including rice straw has been disclosed. In such instance, rice straw may be chopped into lengths of about ¼ to 1 inch in length and supplied to a steamer. The straw is steamed and refined in the steamer for approximately 5 to 30 seconds. A resin such as methyl diisocyanate is added into the steamed rice straw and the straw is then dried at about 350° F. The refined straw with a preferable moisture content of about 8 to 15% is fed into a mat forming press. The straw is pressed under a pressure of 400 to 800 psi with a temperature of about 400° F. The final boards made are about ½ inch in thickness. In addition to chopping the fibers into small lengths, the high temperature and pressure used in this process disintegrates the straw into small fibers that are unsuitable for textile and other high value fibrous applications.

An additional disclosure provides a method of producing pulp for paper from non-wood sources such as straw. In this method, the raw material is treated with about 10 to 30% of alkali solution based on the weight of the material with temperatures ranging from ambient to about 150° C. under pressures ranging from atmospheric to about 30 PSI for about 30 to 60 minutes. Fiber bundles are mechanically separated from the treated material and the dissolved substances called black liquor is removed. The alkali treated material is then treated with acids with or without chelating agents to remove metals. The pH of the solution is preferred to be in the range of 1.5 to 3 for this treatment. The acid treatment is carried out at ambient to 90° C. for 30 to 60 minutes. An ozone treatment may be given to the acid-treated material depending on the end use and brightness of the paper required. Typical ozone treatment is done using about 0.4 to 1.0% ozone on the weight of the fiber at temperatures of 25 to 30° C. for about 5 to 15 minutes. The pulp obtained after the ozone treatment may be bleached to obtain paper with the desired brightness. Again, however, the method described in this invention results in short and partially purified fibers that are unsuitable for textile and other high quality fibrous applications.

Therefore, it would be desirable to provide a method of production of high quality natural cellulose fibers from rice straw.

### SUMMARY OF THE INVENTION

Accordingly, the present invention provides a process to produce high quality natural cellulose fibers from rice straw with properties similar to that of linen. Fibers here are defined as a bundle of single cells held together by lignin and other binding materials and hereafter referred to as “rice fibers”. Single cells are the smallest morphological units of cellulose in the straw and fibers. The rice fibers described here have the fineness, strength and elongation required for use in textiles, composites, and other high value applications. About 40 million tons of natural cellulose fibers world wide and more than a million ton of fibers in the United States of America may be produced every year by using 50% of the available rice straw. Producing fibers from rice straw may not only provide an environmentally friendly alternative to the natural and synthetic fibers currently in use, but may add value to the rice straw and benefit the farmers economically. In addition, this alternative use of rice straw may mitigate the problems associated with the burying or burning of rice straw.

In a first aspect of the present invention, a method of fiber extraction is provided. In the present aspect, the method may include treating rice straw with an alkali solution. For example, the alkali solution may be sodium hydroxide. Further, the method may include extracting coarse rice fibers from the rice straw and treating the extracted coarse rice fibers with an enzyme solution. For instance, the enzyme solution may include cellulase and a xylanase preparation.

In accordance with a further aspect of the present invention, extracted rice fibers that are at least 10 millimeters in length, no more than 0.5 millimeters in width and include a generally smooth surface are disclosed. In an aspect, a textile product including such extracted rice fibers is provided. For example, the textile product is at least one of yarn, woven material, non-woven material, apparel, carpet, automotive fabric, or a medical textile. In a further aspect, a composite including extracted rice fibers of at least 10 millimeters in length and no more than approximately 0.5 millimeters in width is provided.

In accordance with an additional aspect of the present invention, a fiber extraction kit is provided. In such aspect, the fiber extraction kit may include an alkali solution and an enzyme solution. In a preferred aspect, the alkali solution includes sodium hydroxide and the enzyme solution includes cellulase and a xylanase preparation. For instance, the alkali solution may include 1 N sodium hydroxide while the enzyme solution may include 1% cellulase and 1% xylanase (percentage being based upon the weight of the extracted rice fiber weight after alkaline treatment). Treatment of rice straw with the alkali solution followed by the enzyme solution allows rice fiber cells to be extracted from the rice straw. The kit may also include a washing solution for washing the rice straw following treatment with the alkali solution or the enzyme solution. Moreover, a neutralizing solution may also be included to neutralize any remaining alkali on the fibers following alkali treatment.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustration of a method of production of high quality cellulose fibers isolated from rice straw in accordance with an exemplary embodiment of the present invention;

FIG. 2 is a tabulation illustrating the composition of rice fibers following alkali and enzyme extraction in accordance with an exemplary embodiment of the present invention;

FIG. 3 is a tabulation of the crystalline parameters of rice fibers;

FIG. 4 is a schematic of the unit cell of cellulose crystal in rice fibers with “b” axis of the unit cell being the axis parallel to the fiber axis;

FIG. 5 is a X-ray diffraction image of rice fibers with short and bright diffracting arcs indicating the orientation of the cellulose crystals in rice fibers;

FIG. 6 is a tabulation of a comparison of rice fiber properties with other common fibers;

FIG. 7 is a scanning electron microscope image of an untreated rice straw, wherein surface deposits are revealed;

FIG. 8 is a scanning electron microscope image of a rice fiber bundle obtained after alkali and enzyme treatments in accordance with an exemplary embodiment of the present invention, wherein the surface is relatively void of deposits;

FIG. 9 is an exemplary cross-section of an untreated rice straw illustrating an inner core wrapped by an outer sheath in which bundles of single cells are presented within both the sheath and core;

FIG. 10 is a scanning electron microscope image of a rice fiber with single cells, wherein the single cells include a small lumen at the center;

FIG. 11 is an image of single cells obtained by macerating the rice fibers in accordance with an exemplary embodiment of the present invention;

FIG. 12 is a tabulation of ring spinning parameters in accordance with an exemplary embodiment of the present invention which may be employed to process rice fibers; and

FIG. 13 is a tabulation of open-end spinning parameters in accordance with an exemplary embodiment of the present invention which may be used to process rice fibers.

### DETAILED DESCRIPTION OF THE INVENTION

Reference will now be made in detail to the presently preferred embodiments of the invention, examples of which are illustrated in the accompanying drawings.

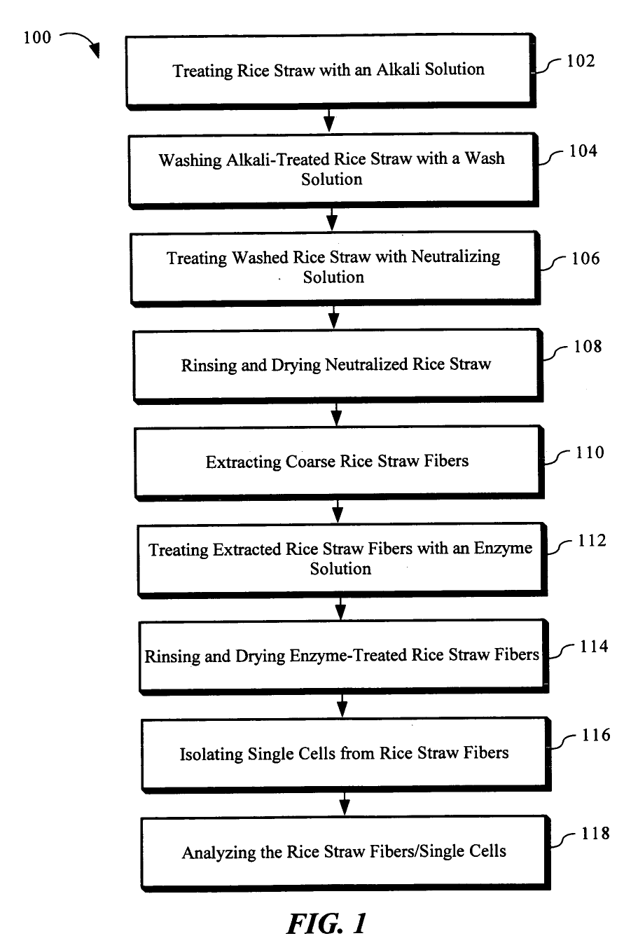

Referring to FIG. 1, a method 100 of fiber extraction is provided. Rice fibers here are defined as natural cellulose fibers derived from rice straw formed by a bundle of single cells held together by lignin and other encrusting substances. Any variety or species of rice straw is suitable for producing rice fibers according to the method described in this invention. The straw need not be from rice plants ready for harvest. However, dried straw available after harvesting the rice would be preferred for fiber extraction. The straw may be washed or treated with chemicals such as alcohols to remove remaining contaminates. Further, the straw may be cut to desired lengths prior to the alkali treatment to obtain rice fibers suitable for processing on the textile machinery.

In an exemplary embodiment, the method 100 may include treating rice straw with an alkali solution 102. For example, the alkali solution includes sodium hydroxide (in anhydrous or liquid form). Alkali concentration used may depend on the quality of rice fiber required and also on the time and temperature of treatment. Preferable concentrations are between 0.1 to 5 N of sodium hydroxide or another alkali with the same alkalinity. The temperature of treatment varies with concentration and time of treatment. Preferable temperature is between 40° C. and 150° C. and most preferably below 100° C. to avoid degradation of the rice straw into singe cells or a bundle of single cells that are too small for high value applications. Duration of treatment is again dependent on the concentration of alkali and the temperature at which the treatment is carried out. Shorter treatment times at higher temperature and concentrations are preferred for practical reasons and for commercial application. Preferable duration is between 10 to 240 minutes with the most preferable duration between 20 and 60 minutes. The ratio of rice straw and alkali used for fiber extraction will also affect the quality and yield of the rice fibers produced. Alkali to material ratio of approximately 1:5 to 1:40 is suitable for rice fiber extraction, more preferably ratios are between approximately 1:5 and 1:25.

The process of alkaline extraction may be carried out in open baths, but preferably in a closed container and under atmospheric conditions to avoid oxidative degradation of rice straw fibers. The alkaline solution and the rice straws may be heated using any heating method. Preferably, the process is carried out in equipments having precise temperature control allowing more accurate temperature control. After the rice fiber extraction, the alkali may be purified and reused for further extraction, if desired. Such action may assist in minimizing the cost of extraction and disposal.

Following treatment with the alkali solution, the method 100 may include washing the treated fibers 104 with a wash solution (e.g., water) to remove the dissolved substances. In a preferred embodiment, the rice fibers are washed in cold water until the dissolved lignin and other materials are removed and clean rice fibers are obtained. Washing may be done in any suitable method as contemplated by one of ordinary skill in the art in order to remove impurities and dissolved substances, but not the desired rice fibers. Preferably, after washing, excess water is removed from the rice fibers by centrifugation or vacuum. Further, any remaining alkali in the rice fibers may be neutralized 106 by employing a dilute acid solution. Any acid including acetic acid may be used for neutralization. In an advantageous embodiment, 10% acetic acid is used with a liquid-to-fiber ratio of approximately at least 5:1 and preferably 10:1. The neutralized rice fibers may then be rinsed in water and dried 108. In an embodiment, the fibers are dried under ambient conditions (approximately 23° C.±2° C.) or at higher temperatures using hot air ovens, infrared driers or other drying methods. The drying time may vary depending upon the extent of moisture desired in the rice fibers. It is preferred that no liquid remain in order to prevent bacterial and fingal decomposition due to the presence of moisture.

Further, the method 100 may include extracting coarse rice fibers from the rice straw 110 and treating the extracted coarse rice fibers with an enzyme solution 112. For instance, the enzyme solution may include cellulase and a xylanase preparation. Enzymes in concentrations of approximately 0.1 to 10% on weight of the fiber may be employed for the treatments. The enzyme treatments may be carried out at ambient to approximately 60° C. for 20 to 1200 minutes with liquid to fiber ratio of 5:1 to 100:1. The pH of the solution may range from approximately 3.0 and 8.0. In an advantageous embodiment, the xylanase preparation is Pulpzyme® and the extracted coarse rice fibers are exposed to the enzyme solution for 40 minutes at 55° C. with a fiber to solution ratio of approximately 1:10 at a pH of approximately 6.0.

The method 100 provides a process of controlled delignification of the rice straw to remove the lignin and other interconnecting materials. The process also aids in partially removing the coloring matter in rice straw resulting in the formation of yellowish-white rice fibers. In such method, rice straws are treated with a preferred alkali concentration in the range of approximately 0.1 to 5 N at temperatures of approximately 40° C. to 150° C. The treatment times being between 10 to 240 minutes, preferably between 20 to 40 minutes for delignification to occur. Various chemicals that assist in delignification and rice fiber extraction such as sodium sulfite, sodium chlorites, chelating agents such as EDTA and some surfactants may also be used in the process. Rice fibers obtained after the alkali treatment are preferably subjected to an enzyme treatment to obtain finer and better quality fibers for the enzyme solution allows for further removal of lignin and other interconnecting materials.

In an embodiment, rice fibers obtained after the enzyme treatment may be washed in a wash solution (e.g., water) and dried 114 under ambient conditions (approximately 23° C.±2° C.). The resulting rice fibers are multicellular in which single cells are bonded together by lignin and other materials. In a further embodiment, the method 100 may include isolating single cells from the rice fibers 116 obtained after the alkaline and enzyme treatment. For example, single cells may be isolated by maceration. Such process may result in single cells with a length of approximately 0.6±0.15 millimeters and a width of 8.1±1.35 micrometers. The method 100 may also include analyzing the rice fibers 118 to determine fiber composition, morphology, and physical structure.

In accordance with an additional embodiment of the present invention, a fiber extraction kit is provided. In such embodiment, the fiber extraction kit may include an alkali solution and an enzyme solution. In a preferred embodiment, the alkali solution is a sodium hydroxide solution and the enzyme solution includes cellulase and a xylanase preparation. For instance, the alkali solution may include 1 N sodium hydroxide while the enzyme solution may include 1% cellulase and 1% xylanase such as Pulpzyme® (percentage being based upon the weight of the extracted rice fiber weight). Treatment of rice straw with the alkali solution followed by the enzyme solution allows rice fibers suitable for textile applications to be extracted from the rice straw. The kit may also include a washing solution (e.g., water) for washing the rice straw following treatment with the alkali solution or the enzyme solution and a neutralizing solution for neutralizing any remaining alkali on the rice fibers following alkali treatment.

Some of the specific examples in accordance with exemplary embodiments of the present invention are provided below.

### EXAMPLE 1

### Extraction with Alkali Solution (Sodium Hydroxide)

Rice straw was treated with a sodium hydroxide at a concentration of 1N for 40 minutes at 100° C. with 5% of straw by weight in the alkali solution. The treated fibers were washed in water to remove the dissolved substances and the fibers formed were dried under ambient conditions. About 10% of the initial weight of rice straw used was obtained as high quality rice fibers after the alkali treatments.

### Example 2

### Treatment with Enzyme Solution

Rice fibers obtained after the alkali treatments were treated with 1% (on weight of the fiber) each of Pulpzyme® and cellulase. The enzyme treatment was carried out at 55° C. for 40 minutes with 5% of the fibers in the enzyme solution at a pH of 6.0. Rice fibers obtained after the enzyme treatment were thoroughly washed in water and dried under ambient conditions. The properties of the high quality rice fibers obtained after the alkali and enzyme extraction are described in detail below.

### Example 3

### Treatment with Alkali Solution (Sodium Carbonate)

Sodium carbonate of 2 N concentrations at boil for 90 minutes was used to extract rice fibers. The rice fibers obtained were washed in water, neutralized using 10% acetic acid. The rice fibers were rinsed in water and air-dried at ambient temperature. Rice fibers obtained were coarse and brownish yellow in color. Higher rice fiber yield of about 10 to 12% was obtained under these conditions. However, fiber quality measured by length, strength and other quality factors was reduced compared to fiber quality obtained after the sodium hydroxide and enzyme treatments.

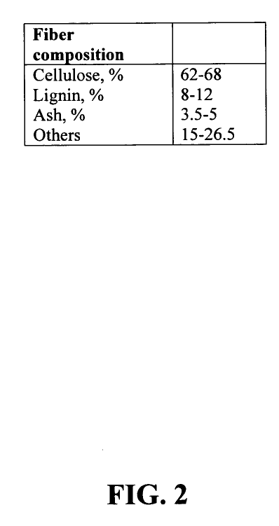

Referring to FIG. 2, a tabulation illustrating the composition of rice fibers following alkali and enzyme extraction in accordance with an exemplary embodiment of the present invention is provided. Rice straw generally contains about 40% cellulose, 30% hemicellulose, 15% silica and about 15% lignin. About 50% of the cellulose in straw i.e. 15 to 20% of the weight of the straw used is obtained as high quality rice fibers after the alkali and enzyme treatment. The remaining cellulose results in short fibers that are unsuitable for high quality fibrous applications and are removed during washing. The alkali and enzyme extraction also removes some of the hemicelluloses, silica and part of the lignin in the straw. The extent of removal of these substances and the amount of high quality rice fibers obtained depends on reaction variables such as chemical concentration, time and temperature of treatment used.

As illustrated in FIG. 2, rice fibers obtained by use of the method 100 on average are composed of 62-68% cellulose, 8-12% lignin, and 3.5-5% ash. It is contemplated that the remaining constituents (denoted as other) is hemicellulose. The resulting cellulose content in rice fibers is similar to that in linen (64%), but lower than that in comhusk, cornstalk and pineapple leaf (PALF) fibers which have about 80% cellulose. The lignin content in rice fibers is higher than that in linen (2%), but similar to that in cornhusk and cornstalk fibers cellulose. Although rice straw has about 15-20% silica, most of it is removed during fiber extraction and the resultant rice fibers following fiber extraction have less than 5% silica by weight.

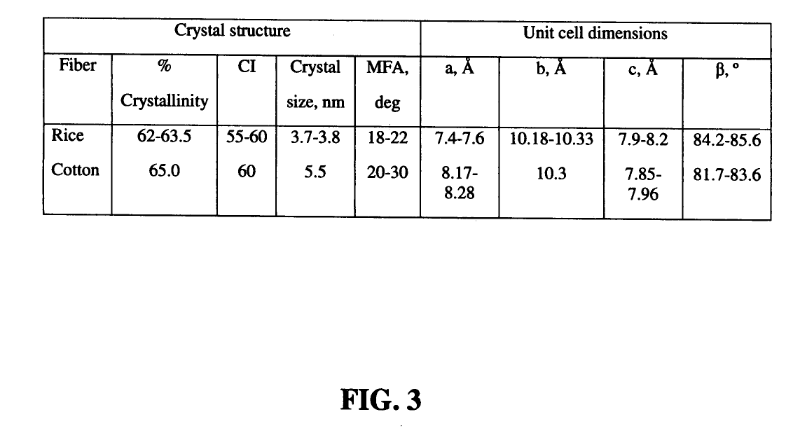

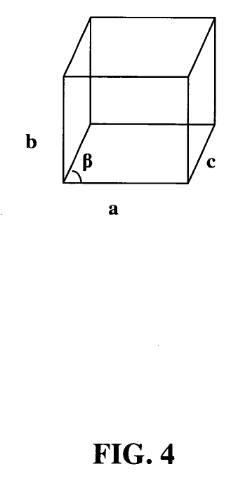

Referring to FIG. 3, the crystalline parameters of rice fibers in terms of the percent crystallinity, crystal dimensions and orientation in terms of crystallinity index (CI) are provided. The percent crystallinity of rice fibers at between 62 and 63.5% which is similar to the percent crystallinity of linen (65%), but higher than that in cornhusk, cornstalk and PALF fibers which have about 50% crystallinity. As illustrated in FIG. 3, rice fibers and cotton fibers have similar b and c axes and differing a axes. A schematic of the unit cell of cellulose crystal is shown in FIG. 4 where “b” axis is the axis parallel to the fiber axis. The difference in the a axis between cotton cellulose and cellulose in rice fibers may be due to the different sources of cellulose being compared. The β angle of cellulose crystals in rice fibers is close to the 84° β angle recognized for cotton. Based on the unit cell dimensions, it is reasonable to believe that the rice fibers have cellulose I crystal structure similar to that found in native cotton and other common cellulose fibers. Cellulose crystals in rice fibers range between 3.7 and 3.8 nm which are larger than that in linen (2.8 nm), but similar to that in coinhusk and cornstalk fibers (3.2 and 3.8 nm, respectively).

With continued reference to FIG. 3, the crystallinity index (CI) and microfibrillar angle (MFA) for rice fibers are provided. CI and MFA indicate the arrangement of cellulose crystals in rice fibers. The higher the CI, the better the orientation of the cellulose crystals to the fiber axis. In contrast, a higher MFA value is associated with a lower elongation. Use of the method 100, results in rice fibers with a lower CI but higher MFA than linen. For instance, exemplary rice fibers have a CI value ranging between 55 and 60 compared to that of linen with a CI value of 70. In contrast, exemplary rice fibers have a MFA value ranging from 18 to 22° while linen generally has a MFA value ranging from 6 to 10°.

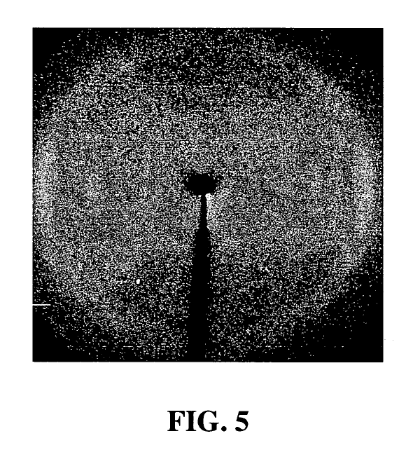

In addition to the quantitative determination of orientation of cellulose crystals in the fibers, the orientation of the crystals may be visually assessed from the patterns of the diffracting arcs in an X-ray diffraction picture. A long and diffuse diffracting arc may indicate a poorly oriented fiber whereas a sharp and bright diffraction arc means a fiber with oriented crystals. FIG. 5 shows the diffraction pattern of the rice fibers. As may be observed from the FIG. 5, rice fibers have bright and short diffraction arcs indicating the better orientation of the cellulose crystals in rice fibers.

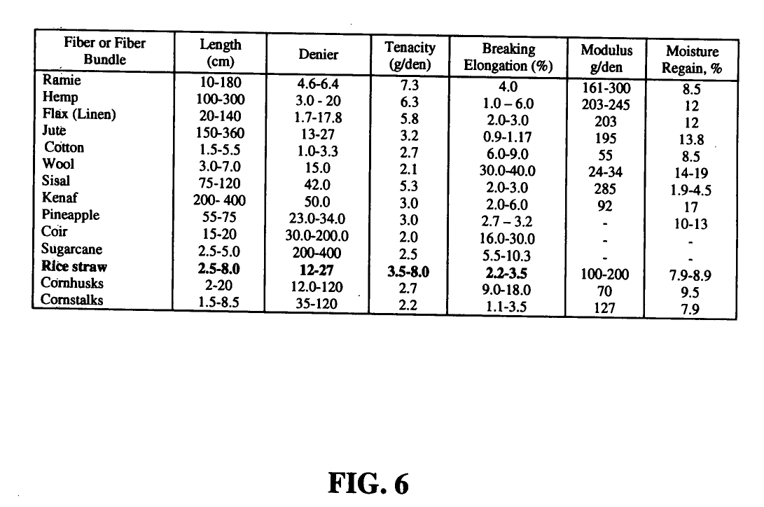

Referring to FIG. 6, a tabulation illustrating the tensile properties and moisture regain of rice fibers in accordance with an exemplary embodiment of the present invention is provided. Fibers obtained from rice straw have lengths from 2.5 to 8.0 cm and an average denier of 27 as shown in FIG. 6. Factors such as the length and width of the single cells may play a major role in determining the length and fineness of the rice fibers obtained. The rice fibers have similar length, but lower width of single cells in comparison to the fibers obtained from cornstalks and cornhusks and therefore they can be used to obtain relatively finer denier fibers. The strength of the rice fibers of approximately 3.45 g/denier is higher than that of cornhusk, cornstalk or pineapple leaf fibers which have strengths of about 2.7, 2.2 and 3.0 grams per denier, respectively. Further, the elongation of the rice fibers of approximately 2.19% is similar to that of cornstalk and PALF fibers (2.2%), but is lower than that of comhusk fibers (13-16%). The higher % crystallinity and better orientation of the cellulose crystals in rice fibers contribute to its higher strength and lower elongation compared to the other biomass fibers.

With continued reference to FIG. 6, rice fibers have a modulus of about 200 g/denier, similar to that of linen (203 g/denier), but higher than that of cornhusk and cornstalk fibers (36 and 127 g/denier, respectively). Modulus of a fiber may determine the softness and flexibility of the products made from the fibers. A lower modulus means a softer and flexible fiber. Although rice fibers have relatively high modulus compared to cornhusk and cornstalk fibers, products made from the rice fibers may be durable because of their high work of rupture which is similar to that of linen and cornstalk fibers. The fineness, length, strength, elongation and modulus of rice fibers indicate that rice fibers are more close to that of linen and would be suitable for most fibrous applications.

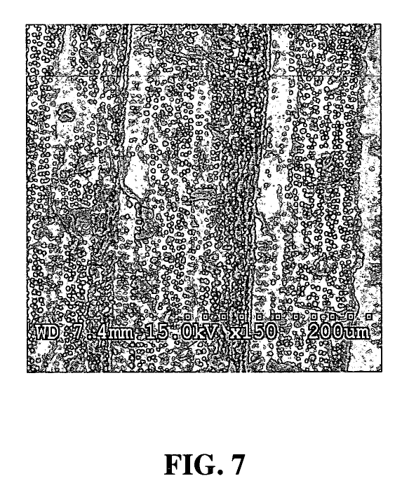

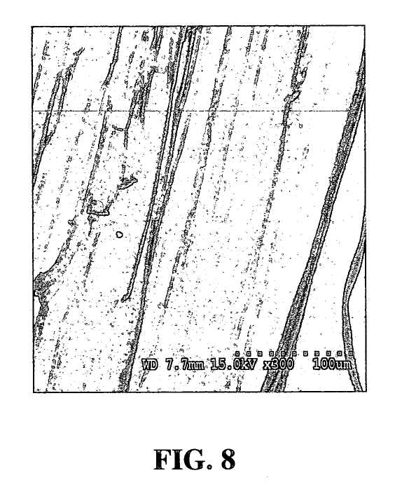

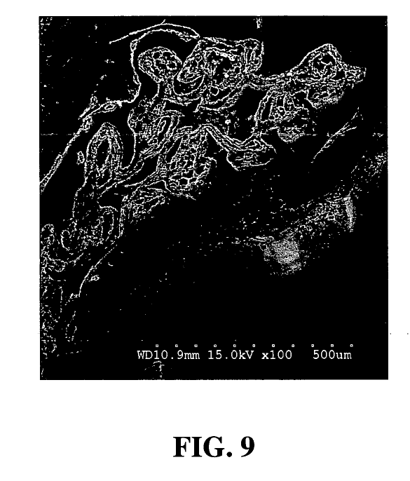

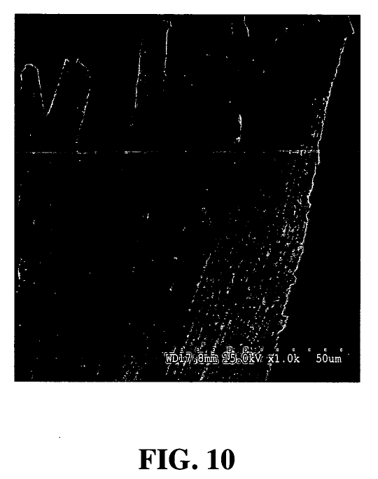

Referring to FIG. 7 through 11, the morphological features of the untreated rice straw, the rice fibers obtained after the alkali and enzyme treatments and the single cells are provided. As illustrated in FIG. 7, untreated rice straw has a layer of substances mostly composed of lignin, silica and other non-cellulosic substances on the outer surface. The alkali and enzyme treatments remove most of the surface substances resulting in rice fiber bundles that have a generally smooth surface as shown in FIG. 8. A generally smooth surface may be defined as a rice fiber with no more than approximately 12% lignin by weight. In an additional embodiment, a generally smooth surface may be defined as a rice fiber with no more than approximately 5% silica by weight. FIG. 9 shows a cross-section of an untreated rice straw in which a distinct inner core wrapped by an outer sheath may be seen. Both the outer sheath and the inner core may be used for fiber extraction. The inner core includes more tightly packed single cells held in bundles. FIG. 10 illustrates an additional cross-section of a rice fiber bundle which includes a number of single cells held together. As illustrated in FIG. 10, the single cells may include a thick cell wall and a lumen. The lumen is relatively small when compared to the lumen in cells walls of other fibers such as cornhusk fibers. The voids that are present between the single cells may be due to the removal of binding materials such as lignin and hemicellulose during fiber extraction.

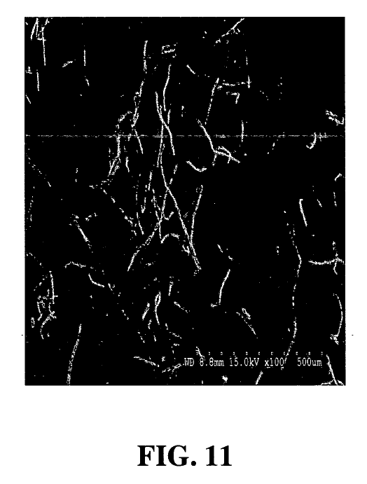

As illustrated in FIG. 11, single cells isolated from rice fibers in accordance with an exemplary embodiment of the present invention, may have lengths of about 0.3-0.8 mm. The length of the single cells in rice fibers is similar to those in other sources of biomass such as cornhusk and cornstalks which have single cells of about 0.5 to 1.5 mm. However, single cells in rice fibers are finer than those in cornstalk and cornhusks which have single cell widths of 10 to 25 and 14 to 35 μm, respectively, compared to 8 to 15 μm in rice fibers. Finer fiber bundles may be obtained with smaller width singles cells compared to fibers having wider width single cells. The single cells in rice fibers may be circular, include tapered ends.

Rice straw is an economical, abundant and annually renewable source for natural cellulose fibers. For the first time, rice fibers with properties similar to that of linen have been produced using an economical and environmentally friendly process. Fibers obtained from rice straw have structure and properties similar to the common fibers in use for textiles. The composition, structure and properties of the rice fibers indicate that the fibers are suitable for most high quality fibrous applications. Rice fibers are probably suitable for blending with cotton, linen and other fibers to produce textiles and composites due to the similarities in structure and properties of rice fibers with the common cellulose fibers. Using rice straw for high quality fibrous applications may add value to the rice crops, mitigate concerns on the burning or disposing of rice straw and provide an environmentally friendly alternative to replace at least a part of the environmentally unfriendly natural and synthetic fibers currently in use.

It is contemplated that rice fibers may be used for apparels, home furnishings, automotive and medical textiles, carpets, and the like. Specific examples of products utilizing rice fiber obtained by the disclosed methods are provided.

### EXAMPLE 1

### Ring Spun Yarns from Blends of Rice Fibers with Cotton

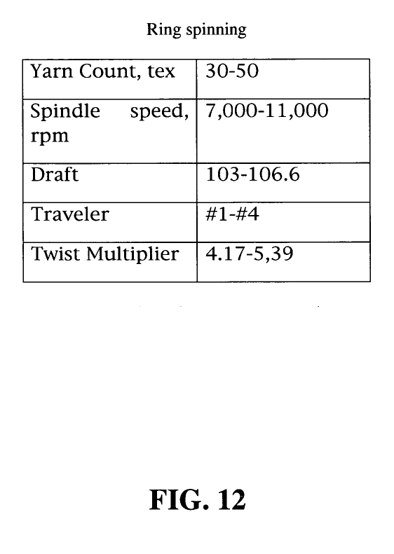

Rice fibers obtained by the method 100 were processed on the conventional spinning machines. Rice fibers obtained from rice straw with an average of 20 denier were processed using a miniature spinning machinery. Rice fibers were hand blended with cotton in the weight ratio of 50/50. The rice fiber blends were processed through a modified card and drawframe to obtain the required grain sliver. All samples were carded twice for uniform mixing and parallelization of the rice fibers. Slivers from the drawframe were spun directly on a miniature sliver to yarn ring spinning machine. Parameters on the ring spinning machines were adjusted to obtain various counts of yarns. The finest yarns produced from 50/50 rice fiber/cotton blends were of 30 tex. The parameters used to process the rice fiber blends on the ring spinning machines are provided in FIG. 12. The properties of the rice fiber/cotton blended yarns were tested on standard yarn testing machines. Results show that the blended yarns have 80% of the strength and similar elongation compared to 100% cotton yarns of the same count produced using the conditions used to produce the blended yarns.

### EXAMPLE 2

### Open-End Spun Yarns from Blends of Rice Fibers with Cotton

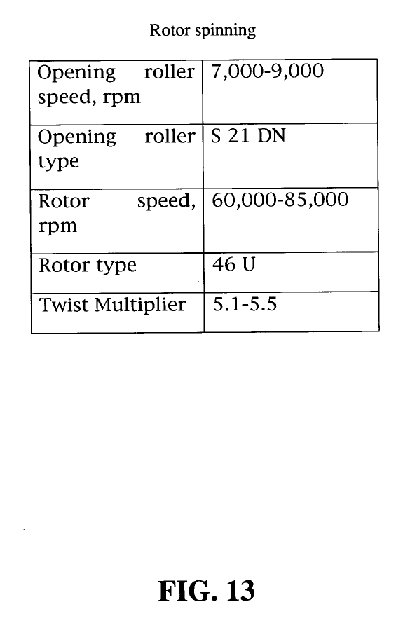

Various ratios of rice fibers were blended with cotton and processed on the open end spinning machines. The fibers were hand blended, processed on the card and drawframe to produce slivers. The silvers were spun into yarns on a Rieter open end spinning machine. The parameters that were used to produce various blends and counts of rice fiber/cotton yarns on the open end spinning machines are given in FIG. 13. Such parameters produced 84 tex rice fiber/cotton blended yarns in the ratio of 35% rice fiber to 65% cotton on the open end machine. The yarns formed had about 65% strength and 80% elongation retention compared to a 100% cotton yarn of the same count produced using the same conditions of producing the blended yarn.

### EXAMPLE 3

### Ring-Spun Yarns from Blends of Rice Fibers with Polyester

Rice fibers with an average of 20 denier were hand blended with polyester in the weight ratio of 65% polyester to 35% rice fibers. The rice fiber blends were processed through a modified card and drawframe to obtain the required grain sliver. All samples were carded twice for uniform mixing and parallelization of the rice fibers. Slivers from the drawframe were spun directly on a miniature sliver to yarn ring spinning machine. Parameters on the ring spinning machines were adjusted to obtain various counts of yarns. The finest yarns produced from 65/35 polyester/rice fiber blends were of 27 tex. The properties of the polyester/rice fiber blended yarns were tested on standard yarn testing machines. Results show that the rice fiber blended yarns have similar strength and elongation compared to 65/35 polyester/cotton yarns produced using the conditions used to produce the rice fiber blended yarns.

### EXAMPLE 4

### Composites from Rice Fibers

Rice fibers with the structure and properties as described above were made into composites intended for use in the automotive headliner industry. Rice fibers in the ratio of 50 to 70% were blended with synthetic fibers such as polyester, polypropylene and polylactic acid. The fiber blend was carded to align the fibers. The carded web was then subject to a water lay process where the fibers become entangled to each other. The carded web is then dried and pressed at 200° C. for about 2 minutes. A composite with a thickness of about 3 to 4 mm was obtained by this process. In an advantageous embodiment, composites were produced from rice fibers blended with other synthetic fibers. Such embodiment was advantageous for it resulted in the production of composites with greater tensile strength and resiliency than composites produced from 100% synthetic fibers alone. It is contemplated that similar composites may be produced from 100% rice fibers and in other ratios of rice fibers with synthetic fibers or polymers.

In addition to the rice fibers and products from the high quality rice fibers, any product made using the short cellulose fibers and hemicellulose obtained as byproducts during rice fiber production are contemplated to be within the scope of the present invention.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. Further, it is to be understood that the claims included below are merely exemplary of the present invention and are not intended to limit the scope of coverage which has been enabled by the written description.

What is claimed is:

1. A method of fiber extraction, comprising:
treating rice straw with an alkali solution;
extracting coarse rice fibers from the rice straw; and
treating the extracted coarse rice fibers with an enzyme solution, the enzyme solution including cellulase and a xylanase preparation.

2. The method as claimed in claim 1, wherein the alkali solution is between 0.1 to 5 N.

3. The method as claimed in claim 1, wherein the treating rice straw with the alkali solution includes treating the rice straw at temperatures in the range of 40 to 150° C. in the alkali solution for ten (10) to two hundred and forty (240) minutes.

4. The method as claimed in claim 1, wherein treating the extracted coarse rice fibers with the enzyme solution includes exposing the rice straw or the alkaline extracted coarse rice fibers to the enzyme solution for twenty (20) to twelve hundred (1200) minutes, wherein the enzyme solution is 0.1 to 10% based on the weight of the rice straw or the coarse rice fibers at a temperature between ambient and sixty (60) degrees Celsius.

5. The method as claimed in claim 1, further comprising treating the rice fibers with a neutralizing solution following treatment of the rice straw with the alkali solution.

6. The method as claimed in claim 1, further comprising washing and drying the extracted coarse rice fibers following the treating the rice straw with the alkali solution and the treating the extracted coarse rice fibers with the enzyme solution.

7. The method as claimed in claim 1, wherein the extracted rice fibers are at least ten (10) millimeters in length and no more than 0.5 millimeters in width.

8. The method as claimed in claim 1, wherein the extracted rice fibers are used to produce a textile product including at least one of yarn, woven material, non-woven material, apparel, carpet, automotive fabric, or medical textile.

9. The method as claimed in claim 1, wherein the xylanase preparation is Pulpzyme.

10. A textile product, comprising:
extracted rice fibers, wherein the extracted rice fibers are at least ten (10) millimeters in length and no more than 0.5 millimeters in width.

11. The textile product as claimed in claim 10, wherein the textile product is at least one of yarn, woven material, non-woven material, apparel, carpet, automotive fabric, or a medical textile.

12. A composite product, comprising:
extracted rice fibers, wherein the extracted rice fibers are at least ten (10) millimeters in length and no more than 0.5 millimeters in width.

13. An extracted rice fiber with a length of at least ten (10) millimeters in length, no more than 0.5 millimeters in width, and includes a generally smooth surface.

14. A fiber extraction kit, comprising:
an alkali solution; and
an enzyme solution, the enzyme solution including cellulase and a xylanase preparation,
wherein treatment of rice straw with the alkali solution followed by the enzyme solution allows rice fibers to be extracted from the rice straw.

15. The fiber extraction kit as claimed in claim 14, wherein the alkali solution is a sodium hydroxide solution between 0.1 to 5 N.

16. The fiber extraction kit as claimed in claim 14, wherein the enzyme solution includes one (1) percent cellulase and one (1) percent xylanase preparation in which the percentage is based on the weight of the extracted rice fiber weight.

17. The fiber extraction kit as claimed in claim 14, wherein the kit further comprises a washing solution for washing the rice straw following treatment with the alkali solution.

18. The fiber extraction kit as claimed in claim 14, wherein the kit further comprises a washing solution for washing the rice straw following treatment with the enzyme solution.

19. The fiber extraction kit as claimed in claim 14, wherein the kit further comprises a neutralizing solution for neutralizing any remaining alkali on the rice fibers following alkali treatment.

20. The fiber extraction kit as claimed in claim 14, wherein the extracted rice fibers are used to produce a textile product including at least one of yarn, woven material, non-woven material, apparel, carpet, automotive material, or medical textile.
